(19) United States
(12) Patent Application Publication
(10) Pub. No.: US 2016/0091130 A1
(43) Pub. Date: Mar. 31, 2016

(54) Telescopic flow-thru DE filter grid wand

(71) Applicant: Steven E. Thompson, Brooksville, FL (US)

(72) Inventor: Steven E. Thompson, Brooksville, FL (US)

(21) Appl. No.: 14/499,127

(22) Filed: Sep. 27, 2014

(51) Int. Cl. F16L 35/00

(52) U.S. Cl. CPC F16L 35/005

(57) ABSTRACT

A flow-thru telescopic tube apparatus connected at one end point to a fluid water source, such as a garden hose, such that water is forced thru one tube of a specific diameter, which reduces into a second rigid tube of a reduced diameter, of which has no end outlet, and is flared at one end to act as a stop, wherein the tubing is perforated, in part, on the other end, with a plurality of minute outlets of varying opposing orientations to allow pressurized streams of fluid to escape, for the purpose of the cleaning of commercial diatomaceous earth (DE) filter grids. The reduced tubing element has the embodiment of loosely fitting between and around all surface areas of commercial filter grids. The apparatus is comprised of a cam system that adjusts the apparatus length by sliding one tubing section into the other tubing section, locking securely at any point, in a water-tight manner. The cam system consists of a locking collar connecting a male connector at the confluence of the tubes and includes an o-ring, a tightening ring, and a ferrule. The perforated end of the tubing contains a removable plug as an alternative path of directional fluid. A grip may be included. A flow-control valve may be incorporated between the hose connection and the fluid source.

### STATEMENT REGARDING FEDERALLY SPONSORED RESEARCH/DEVELOPMENT

Not Applicable.

### DESCRIPTION

1. Field of the Invention

The present invention relates to fluid distribution equipment and more specifically to a telescopic tube apparatus that fluid water can be directed, for use in the maintenance and cleaning of a Diatomaceous Earth (DE) swimming pool filter.

2. Discussion of the Background

Most commercial swimming pools utilize a water filtration system that consists of a DE grid system that resides in a large tank or pit, whereby a self priming pump draws water from the pit thru a series of circular fabric over skeleton grids coated with DE powder, thereby filtering the water for contaminants. The water flows into the pit by gravity filling the pit for the ready of the pump system. Periodically, i.e., daily, weekly or monthly, the contaminants and DE powder are required to be drained, removed and DE re-applied onto the grids, refreshing the system to maintain proper water flow. Currently, the most common method of cleaning DE Grids is to rinse the grids with a pressure nozzle attached tightly spaced to a garden hose. This method requires a great deal of effort, and does not necessarily clean the grids fully as the technician cannot be assured that the pressurized water is making contact with all of the grid fabric areas. Each grid of a commercial filter system is comprised of a round plastic skeleton covered in fabric on all sides. Each side of a grid is necessary to spray as it is spun on its axis to clean thoroughly and a technician usually must climb down into the drained pit to accomplish the task of cleaning the filter grids. It would then be beneficial to have a method by which a technician could thoroughly clean the filter grids of a commercial DE filter wherein: without having to climb into the filter pit or tank and; to have an apparatus capable of spraying multi-directional streams of pressurized water for the purpose of cleaning two filter grid sides simultaneously and being able to fully articulate, thereby able to reach all areas of, the filter grid surfaces with minimal effort. To this need the present invention is directed.

In Prior Art, other devices, apparatus′, and filter cleaning tools are relegated to pertaining to their respective types of filter elements such as cartridge filters, tube filters, Perflex filters and the like, and are very specific in nature to their respective filter element. The Perflex wand is most related to the present invention, but lacks the sophistication and preferred embodiments of the present invention. The Perflex wand is not adjustable in length, and possesses only one discharge point for fluids. The apparatus of the tube filter cleaner bears mention, as this design in some manner has inside-out relational elements to the present invention. None of the aforementioned apparatus' possess the preferred embodiments of the present invention, in versatility or scope of function and design.

The embodiment of a telescoping pole capable of adjusting to various lengths necessary to clean a filter without bending or climbing into a filter pit, and the embodiment of being capable of fitting loosely between filter grids while delivering a plurality of multi-directional streams of pressurized water, creating a superior, completely directional cleaning capability, would be ideal.

Further, with the additional embodiment of a removable plug at the tip of the apparatus, the present invention allows for the added capability of a forward facing distribution point useful in the focus of directional water to an area or areas within a filter pit or tank for various unlimited purposes.

After review of the background, summary, and detailed description of the preferred embodiments, in conjunction with the drawings, specifications and claims, it should be apparent to anyone skilled in the field of Prior Art, that the present invention uniquely solves the need for a method of cleaning commercial DE swimming pool filters and residential DE grid container filters, that is quicker, less labor intensive and more thorough than traditional methods.

### SUMMARY

A flow-thru telescopic tube apparatus connected at one end point via a moveable female hose connector with o-ring seal to a pressurized fluid water source, such as a garden hose, such that pressurized water is forced thru one rigid tube of a specific diameter, which reduces into a second rigid tube of a substantially reduced diameter, of which has no direct outlet at the end of the reduced diameter tubing, and is flared at one end to act as a stop, wherein the tubing is perforated on the other end, in part, with a plurality of minute outlets of varying opposing orientations to allow fine pressurized streams of fluid water to escape, for the purpose of the cleaning of commercial diatomaceous earth (DE) swimming pool filter grids. The reduced diameter tubing element of the flow-thru telescopic apparatus loosely fits between, and around all surface areas, of the aforementioned commercial DE swimming pool filter grids. The apparatus is comprised of a locking cam system that has the ability to adjust the overall length of the apparatus by sliding the reduced diameter tubing section into the first tube of a specific size, and lock reasonably secure at any point along the apparatus in a water-tight manner. The cam system consists of an internally threaded female cap connecting to a male threaded connector, situated at the conjunction of the two (different) sized tubing, secured to the larger and includes an o-ring, tightening ring and ferrule. Upon tightening the female cap over the tightening ring, ferrule and o-ring, and threading it onto the male threaded connector, the created pressure secures the length of the apparatus and creates a watertight seal. As to the reduced diameter tubing, a flared end opposing the perforated end of the tubing, acts as a stop mechanism when the two sections of tubing are fully extended, bringing the flared end of the reduced diameter tubing in contact with the inner posterior end of the cam connector. The perforated end of the reduced diameter tubing contains a threaded removable plug as an alternative path of directional fluid, not to exceed the diameter of the reduced diameter tubing. A molded slip handle grip may be included on the larger diameter tubing. Further, a flow-control valve may be incorporated between the hose connection and the fluid source.

A complete understanding of the present invention may be obtained by examination of the accompanying drawings when considered in conjunction with the detailed description of the preferred embodiments.

### BRIEF DESCRIPTION OF THE DRAWINGS

In the figures, similar reference numbers refer to similar parts typical through various figures unless noted otherwise. Numerals with letter characters in addition to numerals such as “101A” or “101 B” the letter character designations for reference numerals indicates that two similar parts or elements are present in the same FIGURE. Letter character designations for reference numerals may be omitted when it is intended that a reference numeral encompass all parts having the same reference numeral in all figures.

For a more complete understanding of the present invention, and for further details and advantages thereof, reference is now made to the following detailed description taken in conjunction with the following drawings, in which:

FIG. 1 is a partially exploded perspective view of the telescopic flow-thru DE filter grid wand, including a expanded detailed perspective view of the cam components and an expanded transparent perspective detail view of the cam and inner tubing flare.

### DETAILED DESCRIPTION OF THE PREFERRED EMBODIMENTS

As used in this specification and the appended claims: DE means diatomaceous earth, a naturally occurring, fossilized remains of diatoms, a type of hard shelled algae, ground to a fine white powder, and used as a filter medium for a specific type of swimming pool filter.

In the descriptions which follow, like parts are marked throughout the specification and drawings with the same numerals, respectively. The drawing figures are not necessarily drawn to scale and certain figures may be shown in exaggerated or generalized form in the interest of clarity and conciseness.

Various elements, features and benefits of the embodiments on the present invention will be more apparent with regard to the following description in conjunction with the included drawings. Those skilled in the art that the described embodiments of the present invention included herein are illustrative only and not limiting, and are presented in the way of example only. The features represented in this description may only be substituted with alternate features serving same or similar purposes, unless otherwise expressed. Therefore, other embodiments of modifications thereof are contemplated as falling within the scope of the present invention defined herein and equivalents thereto. Presently disclosed embodiments, as well as features and properties thereof, are directed to provide a telescopic flow-thru DE filter grid wand 17. Upon review of the claims and detailed description, in conjunction with the drawings provided, a person of modest skill in the field of prior art, should recognize the exemplary preferred embodiments of this present invention.

In referring to the drawings of the invention of the telescopic flow-thru DE filter grid wand 17:

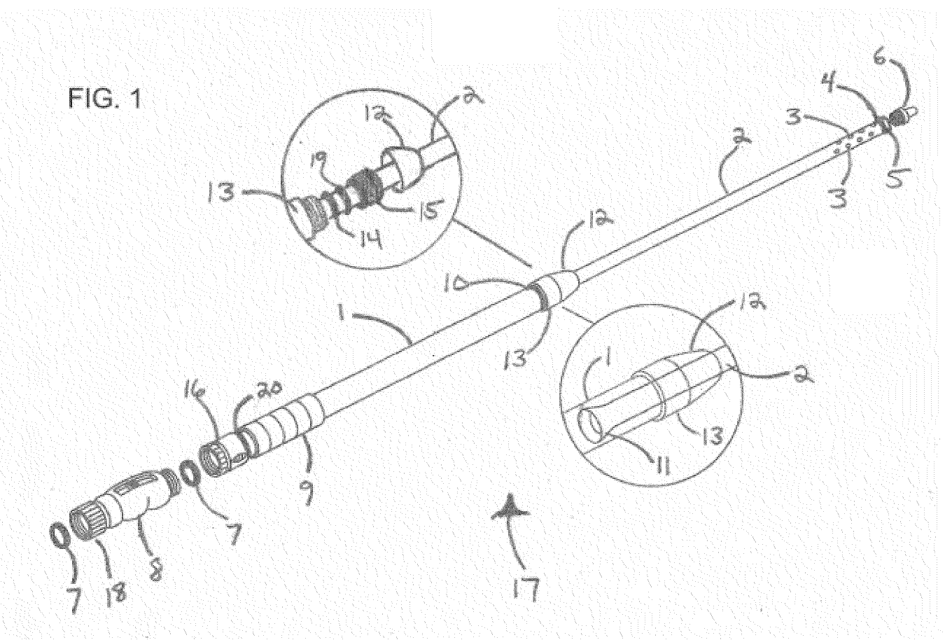

FIG. 1 is a partially exploded perspective view of the telescopic flow-thru DE filter grid wand 17, including an expanded detailed perspective view of the cam components and an expanded transparent perspective detail view of the cam and inner tubing flare 11. The flow-thru telescopic DE grid wand 17 is an apparatus, whereby a rigid outer tube 1 is connected at one end point via a moveable female hose connector 16 with an o-ring seal 20 to a pressurized fluid water source, such as a garden hose, such that pressurized water is forced thru one rigid outer tube 1 of a specific diameter, which reduces into a second inner rigid tube 2 of a substantially reduced diameter, of which has no direct outlet at the end of the reduced diameter rigid inner tubing 2, and is flared 11 at one end to act as a stop, wherein the rigid inner tubing 2 is perforated 3 on the other end, in part, with a plurality of minute discharge points 3 of varying opposing orientations to allow fine pressurized streams of fluid water to escape, for the purpose of the cleaning of commercial diatomaceous earth (DE) swimming pool filter grids. The reduced diameter rigid inner tubing 2 element of the flow-thru telescopic DE grid wand 17 apparatus loosely fits between, and around all surface areas, of the aforementioned commercial DE swimming pool filter grids. The apparatus is comprised of a locking cam system that has the ability to adjust the overall length of the apparatus by sliding the reduced diameter rigid inner tubing 2 into the rigid outer tube 1 of a specific size, and lock reasonably secure at any point along the apparatus in a water-tight manner. The cam system consists of an internally female threaded locking collar 12 connecting to a molded male threaded adaptor 13, situated at the conjunction of the two (different) sized tubing, secured to the rigid outer tubing 1 with a connection o-ring seal 10, and includes a cam o-ring 14, a rigid tightening ring 19 and a ferrule 15. Upon tightening the locking collar 12 over the tightening ring 19, ferrule 15 and cam o-ring 14, and threading it onto the threaded male adaptor 13 fitting, the created pressure secures the length of the apparatus and creates a watertight seal. As to the reduced diameter rigid inner tubing 2, a flared 11 end, opposing the perforated 3 end of the tubing 2, acts as a stop mechanism when the two sections of tubing 1, 2 are fully extended, bringing the flared 11 end of the reduced diameter rigid inner tubing 2 in contact with the inner posterior end of the male adaptor fitting 13. The perforated 3 end of the reduced diameter rigid inner tubing 2 contains an internally threaded bushing 5, made water-tight, by means of an inner bushing seal o-ring 4, as an alternative path of directional fluid, and does not exceed the diameter of the reduced diameter tubing 2, wherein a removable end cap 6 can be threaded into the threaded bushing 5. A molded slip handle grip 9 may be included on the larger diameter tubing 1. Further, a flow-control valve 8 may be incorporated between the hose connection 16 and the fluid source. The connections between the control valve 8 and the water source, and the control valve 8 and the female tubing connector 16, each contain a standard garden hose washer 7.

In the use of cleaning a commercial swimming pool DE filter, comprising of round disc grids, the wand 17 is articulated in a manner by which the rigid inner tubing's 2 perforated discharge points 3 are maneuvered between the filter grids, loosely fitted between two grids at a time. The perforated discharge points 3, being at various orientations, create a plurality of spray that effectively and efficiently removes debris from the surface of the grids. The cam system allows the overall length of the wand 17 to be adjusted to accommodate various sized filter conditions, such as a deep pit or limited overhead room, due to a ceiling or vak pak lid. This feature enables a user to clean a filter without having to climb into the pit, hang over the pit or strain in any way to reach all areas of the filter and pit. The embodiments of the grid wand 17 dramatically reduce the overall time required to clean a filter and with less strain on the user. Further, the embodiment of the removable end cap 6 allows a user to utilize a forward distribution spray for such purposes as targeting a specific area on a filter grid or for use in cleaning the pit itself, such as accessing tight corners or other various hard to reach areas within a pit or filter.

Additionally, the present invention may be used to clean residential DE canister filters. Existing systems require disassembling the entire grid, manifold and base to access the entire surface area of the grids to properly clean the filter. Most manufacturers recommend this process, known as an annual DE cleaning, to be done twice per year. Once the grids are disassembled, a technician or homeowner often has difficulty in reassembling the grids to the proper orientation after cleaning them and have to make several attempts to line-up said grids. If the grids are not fully disassembled, the function of the filter is often somewhat compromised, which puts unnecessary stress on the filter and other equipment, leading to unnecessary equipment damage. The present invention, possessing the embodiment of a narrow, rigid inner tube 2 is able to fit between the grids without the need for disassembling, yet possessing the ability to access all areas of the grid fabric through the embodiment of the variously oriented perforated discharge points 3. This enables a user to deliver a superior caliber of cleaning in a fraction of the time it would normally take to disassemble, clean and reassemble a residential DE filter.

It should be apparent to those skilled in prior art the many benefits to which the preferred embodiments of the present invention possess.

1. A telescopic flow-thru DE filter grid wand used for dispensing fluid water from a source, such as a garden hose, that the apparatus consist of: A rigid outer tube of one specific diameter and a rigid inner tube of a substantially smaller diameter relating to the outer tube comprising of: a female connector by means of which connects the apparatus to a water source; a pathway thru the inner and outer tubes which allows fluid to pass thru to the points of discharge; discharge points, in the number of, but not limited to, twelve small holes in varying orientations encompassing the end section of the inner tube; a means by which the varying connection points between the inner and outer tubes seal to a water-tight state in any extension position; a means by which the varying connection points between inner and outer tubes lock by the means of a cam system that is mounted on the end of the outer tube where the cam creates pinching friction on the inner tubing when the locking member is rotated clockwise; a removable end cap at the end of the inner tubing consisting of a water-tight, by means of a seal, inner bushing mounted into the inner tubing which the center of is threaded female to receive a male threaded plug; a molded sleeve at the fluid connection side of the outer tube for gripping.

2. A telescopic flow-thru DE filter grid wand of claim 1 consisting of a rigid, outer tubing in which a female garden hose connector is internally connected to the tubing, whereas the connection point at the tubing is water-tight by use of a sealing o-ring.

3. A telescopic flow-thru DE filter grid wand of claim 1 consisting of a molded male adaptor fitting which mounts internally into the end of the rigid outer tubing on the end opposing the water connection end and seals water-tight by use of a sealing o-ring.

4. A telescopic flow-thru DE filter grid wand of claim 3 consisting of the molded male adaptor fitting which is threaded on one end and mounts internally into the rigid outer tubing, and of which the center is hollow to allow fluid water to pass thru.

5. A telescopic flow-thru DE filter grid wand of claim 1 consisting of a locking collar, a seal o-ring, a tightening ring and a ferrule which compresses the cam o-ring and ferrule when the locking collar is tightened clockwise onto the threaded molded male adaptor fitting of claim 4, against the ferrule, creating a water-tight seal, locking the tubings, at any point between the rigid outer tubing and rigid inner tubing.

6. A telescopic flow-thru DE filter grid wand of claim 1 consisting of a rigid inner tubing that is flared on one end to act as a stopping mechanism when the rigid inner tubing flare contacts the molded male adaptor fitting of the outer tubing.

7. A telescopic flow-thru DE filter grid wand of claim 1 consisting of a rigid inner tubing which contains as many as, but not limited to, twelve small perforated discharge points in an offset order and varying orientation that allows fluid water to discharge from the inner tubing in varying orientations to create a multi-directional discharge spray for the purpose of cleaning two commercial Diatomaceous Earth (DE) filter grids simultaneously, and maneuver and articulate around all areas of the grids.

8. A telescopic flow-thru DE filter grid wand of claim 1 consisting of a bushing connecting internally to the perforated end of the inner tube, not to exceed the diameter of the inner tube, with an o-ring seal to a water-tight state.

9. A telescopic flow-thru DE filter grid wand of claim 8 consisting of an internally threaded bushing connection, whereas the bushing connection is female threaded hollow to allow fluid water to pass thru and allow a male threaded end cap plug to thread into the bushing to create a water-tight seal or, in its removed state, create a directional flow of fluid water to spray out forward, for use in cleaning a DE filter grid or pit.

10. A telescopic flow-thru DE filter grid wand of claim 1 consists of a rigid inner tubing that the diameter of the inner tubing allows the inner tubing to fit between standard DE filter grids in a manner that an individual of ordinary skill can maneuver the telescopic flow-thru DE filter grid wand to any articulation required to accomplish the task of cleaning a DE filter.

11. A telescopic flow-thru DE filter grid wand of claim, or any part thereof, may be constructed out of plastic.

12. A telescopic flow-thru DE filter grid wand of claim 1, or any part thereof, may be constructed of stainless steel or any rust-resistant metal or metal coating.

13. A telescopic flow-thru DE filter grid wand of claim 1, or any part thereof, may be constructed of aluminum.

14. A telescopic flow-thru DE filter grid wand of claim 1 consisting of a flow control valve located between the fluid water connection and the fluid water source.

15. A telescopic flow-thru DE filter grid wand of claim 1 consisting of a fluid water connection internally attached to the rigid outer tubing including an o-ring seal.
